(19) United States
(12) Patent Application Publication
(10) Pub. No.: US 2016/0148174 A1
(43) Pub. Date: May 26, 2016

(54) Electronic Fund Transfer Reconciliation and Management Method and Device

(71) Applicant: REDE SERVIÇOS LTDA., Belém (BR)

(72) Inventors: Denis Sol Paiva Calandrini, Belém (BR); Augusto Cesar Felipe Da Silva, Belém (BR); Adalcindo Ofir De Souza Magno Duarte, Belém (BR)

(73) Assignee: REDE SERVIÇOS LTDA., Belém (BR)

(21) Appl. No.: 14/759,130

(22) PCT Filed: Apr. 4, 2013
(86) PCT No.: PCT/BR2013/000106

§ 371 Date: Dec. 8, 2015

(51) Int. Cl. G06Q 20/10; G06Q 20/34; G06Q 20/40; G06Q 20/32

(52) U.S. Cl. CPC G06Q 20/10; G06Q 20/3223; G06Q 20/34; G06Q 20/4014

(57) ABSTRACT

The present invention relates to a method of reconciliation and management of electronic fund transfer and card reader device (1) for mobile services network that is embedded in smart mobile apparatus (2) with Internet connection, such as smartphones, tablets, ultra book or notebook to enable the use of these apparatus to perform reconciliations and fund transfer.

### FIELD OF THE INVENTION

The present invention relates to a method of reconciliation and management of electronic fund transfer and card reader device for mobile services network that is incorporated into a smart portable apparatus with Internet connection, such as smartphones, tablets, ultra book or notebook to enable the use of these devices to perform reconciliations and fund transfer.

### PRIOR ART OF THE INVENTION

The use of electronic cards for bank accounts or transactions payments is widespread, and has replaced checks or cash as payment for purchase of goods or contracting services.

This payment method is very advantageous because it reduces the transaction costs and risks associated with the use of cash or check, in addition to facilitating the transaction regardless of the distance between the consumer and the supplier.

The data stored on the card are read by swiping a magnetic strip of the card through or by inserting the card into a reader slot, which identifies the customer data and the card company brand.

Generally, the cards are issued by a bank (issuer) in partnership with a credit card company (acquirer), or can be issued directly by the credit card company.

Most of the existing card reader devices are provided with specific applications for each credit card company brand, and it is not compatible between different credit card company brands.

In order to prevent the need of a lot of equipment by the supplier of products/service, there are devices that can be used by different credit card company brands.

Despite this advantage, both the consumer and the supplier have to pay administrative fees to the credit card company, equipment rent and the equipment is subject to malfunction.

There are certain credit card companies that charge 3.5% for a credit transaction; some of them charge a service surcharge of at least 4% plus a value per transaction (usually this value ranges from BRL 1.00 to 3.00). In addition, there are also fees for the use of their software.

There are companies that capture transactions of different credit card company brands, in order to allow a supplier to make any financial transaction in the same application, but all the phone card data is needed in the cellphone, which requires a lot of time at the moment of a sale, and according to the case, the consumer gives up the purchase.

In addition, most current devices and methods provide management services of a particular form of payment, for example, the device offers a credit card transaction but not banking or cellphone recharge.

In addition to these disadvantages, the equipment currently used are specific to card transactions for financial transactions, there is no other operation provided by the equipment, such as values transfer between bank accounts. There is no equipment available that allow consumers to make their payments or inquiry through their smartphone or tablet, for example.

With the growing use of cards as a means of payments and increased sales due to the easiness of this method of payment or even with the use of e-commerce, the card reconciliations become essential for financial management and especially in the tax obligations.

However, current devices do not provide a reconciliation option (verification) of the transactions performed. Throughout the day hundreds of transactions are held and the consumer needs to make sure that everything is correct, for example, whether the values received are correct; if the rent of the POS (point-of-sale) is being discounted correctly; if the applied rates are the same agreed; how many cancellations a day occurred; how many transactions carriers stopped paying; how to prove their rights to all these receipts; etc.

Performing these steps of reconciliation manually requires investment in human resources to perform these manual tasks according to the high demand of sales transactions by credit card, making the ratio “cost X benefit” totally unfavorable.

The lack of card reconciliation or inefficient manual reconciliation is a serious problem for businesses, and large financial losses can occur, as it is the case in several possible inconsistencies such as differences in values, rates, cancellations and especially chargebacks.

Normally, the control of the values received relating to credit card sales is done through reconciliation of sales statement of the acquires (credit card companies) with the sales records of the supplier, and the result generated by the confrontation of these files allows to evaluate the pending values and differences.

However, to have a satisfactory control, allowing management of values received, reconciliation should be performed with all inherent transaction information, in order to enable to check from transaction to transaction, from the moment of realization of the sale up to the final cycle of the value received.

The detailed work of reconciliation allows the immediate recognition of a divergent transaction, ensuring efficiency and celerity in this method of adjustment request before operators (acquirer or issuer).

The excellence in the result of a reconciliation is directly identify the cause of divergence, when, how, where and in which transaction it occurred, this way it is possible to work directly in the solution of this problem.

In order to allow the consumer to make the reconciliation of all transactions performed without having to do it manually, the present invention provides a device and a method that allows the reconciliation of all transactions made with credit or debit card, or in cash.

It is yet another object of the present invention a device that reads the credit or debit card, being the link between the supplier and the consumer, making the transaction capture, focusing on security questions, reliability and mobility.

The present device can be used by any financial institution or credit card company. It allows receiving cards payments, bank reconciliation of loans or payment of bills.

The said device also allows other services such as: payroll loans, financial situations consultation for credit analysis (for example, databases like Serasa), payment of different distributors of water, gas, energy, mobile recharge and prepaid cards, as well as the possibility of the supplier to launch its own card (private label).

This method has on a single platform, the addition combination of various services. For example, an owner of a newsstand can recharge mobile phones to a consumer using a mobile phone (e.g. Oi, Vivo, Claro or Tim), but consumers have to pay in cash, and cannot do it by credit card, as the phone does not allow such payment. The present device and method makes it possible to use the same mobile card payment also, which increases the possible forms of payments.

Advantageously manner in relation to the prior art, the control is done by the supplier of products/services and by the consumer, where the payment is credited directly to the supplier, without intermediaries, which not only enables its management, as well as there is flat-rate charge, without generating any other kind of costs for the supplier, unlike current systems, such as PagPop and PagSeguro, for example.

Among the many advantages, the method of the present invention allows, for example, the accomplishment of the following services:
Credit Operations Management: receives files from leading credit card companies (e.g., CIELO and REDECARD), and performs cross-checks, i.e. checks to the supplier if the financial transactions actually informed as paid by the consumers were recorded or not within the period covered in the agreement;
Banking Operations of Consumer Account: the consumers can on their own perform bank transfers, installment plans, payment debts operations, waived any payment to financial intermediaries, without being surcharged in such operations, since the present method is integrated with banking solutions to major institutions;
Recharge of Cell Phone: the consumer can perform recharge of a cell phone, since the invention allows the integration with the main companies in the market;
Recharge of Prepaid/Private-label card: the supplier may launch its own card with the solution already prepared for this kind of service, including working with the idea of loyalty by score accounting for use of the card. The supplier can also enable consumers to prepaid cards for use in its store network;
Payroll: enables to perform from the consumer registration by examination of the proposal, going through all the necessary steps to acquire this kind of service;
Financial situations consulting for credit analysis: the method enables consultations of various kind on a particular registration of a person or an entity, for example, in the SERASA EXPERIAN database;
Solution Integration: allows integration of various system solutions for corporate management, such as SAP, TOTVS, Alterdata, DATASUL, etc.;
Payment to distributors of water, gas, energy: allows receiving titles of water utilities, electricity, telephone, gas or by integrating via Web Service;
Reduction of operational risks: the method eliminates the costs with employees who usually travel to the bank for payment a banking billet, as it integrates with any bank that is able to perform electronic transactions, avoiding the risk of robbery;
SUS card: allows the reading of social security cards, such as SUS, in places such as: clinics, hospitals and pharmacies; with patient identification and reporting detailing the services used;
Reconciliation of sale, payment and receipt.

### SUMMARY OF THE INVENTION

The present invention relates to a method of reconciliation and management of electronic fund transfer and card reader device of a mobile network services (NTSV) for use in portable apparatus with an Internet connection, as smartphones, ultra books, notebooks or tablets, by using a computer program, executes the routines of the method, while the device reads the card data and said apparatus performs the tasks requested by the supplier/consumer.

This program can be used on any mobile platforms (Apple, RIM and ANDROID) for credit card transactions. The device is a card reader that is coupled to the audio input of said mobile apparatus (smartphones, tablets, etc.).

By coupling the said device to the tablet, for example, the supplier/consumer registers its access to the program, enabling all the features and benefits; such as: capture of transactions from leading credit cards companies (VISA, MASTERCARD, AMERICAN EXPRESS, DINERS, ELO), recharge of cellphone, prepaid card recharge, credit, payments of distributor (of water, electricity, telephone, gas, etc.), financial statements consulting for credit analysis, prepayment of receivables, bank reconciliation for loans, receiving of own cards (private label model) and payroll loans.

The present device and method can be used for both a business in the private segment and a distributor, from simple sell of a mobile phone recharge of a suburb store to the final consumer to a bank reconciliation of credits.

The device can be used by banks, professionals, small, medium or large retailers, health plans, clinics, pharmacies, bank representatives, distributors, telephony, etc.

### BRIEF DESCRIPTION OF THE FIGURES

Particular embodiments of the invention are described below with reference to the accompanying drawings without any limitation on its scope which is determined solely by the appended claims.

FIG. 1 is a functional block diagram of the reconciliation service;

FIG. 2A is the interface of the present method on a screen of a mobile apparatus (2);

FIG. 2B illustrates the present card reader device (1) where the card is coupled;

FIG. 3 is a schematic representation of the present method in a WAN Network;

FIG. 4A is a block diagram of a product or service purchase method using the present device (1) and method;

FIG. 4B illustrates the logon screen to the method;

FIG. 4C illustrates a menu of selection of services;

FIG. 4D illustrates a screen where the consumer data are requested in a transaction with card;

FIG. 4E illustrates a screen where consumer data is completed;

FIG. 4F illustrates a transaction confirmation screen;

FIG. 4G illustrates a screen where the transaction was unauthorized;

FIG. 5 is a block diagram of the method of financial transaction;

FIG. 6 is a block diagram of the method of FIG. 5 applied to recharge of a prepaid cell phone;

FIG. 7 is a block diagram of a method of payment to distributors;

FIG. 8 is a block diagram of the method of consultation to SERASA databases;

FIG. 9 is a block diagram of the loan request method; and

FIG. 10 is a block diagram for requesting proprietary credit cards.

### DESCRIPTION OF THE CONFIGURATION ILLUSTRATED

The present invention relates to a method of reconciliation and management of electronic fund transfer that are performed through a software application embedded on a smart mobile apparatus with internet connection (2), such as smartphones, tablets, ultra book or notebook; and a card reader device (1) to be coupled to such mobile apparatus (2), in order to facilitate the use of these devices in financial transactions.

The card reader device (1) comprises an opening for insertion/swipe of a financial transaction card, such as bank card, credit card, smartcard, loyalty card, etc. The said opening is where it is made the reading of the card. It is equipped with a connector that is pluggable to the headphone input of the said mobile apparatus (2). The said device (1) is capable of performing readback data; it supports TDES and AES encryption; it is compatible with Apple, Android and Blackberry; and it reads two tracks of data in a single swiping of the card.

The use of the mobile apparatus (2) is advantageous because it comprises elements necessary to implement this method, whose program is installed on the same mobile apparatus (2). Its screen serves as an interface to the supplier/consumer for the exchange of information and it displays the reconciliations and financial transactions status; and its connection to the Internet system enables the information exchange with databases of a manager (RDSV—REAL DISCOUNT SERVICE), banks, credit card companies, services distributors, mobile operators, etc.

The present invention eliminates the usual card reader device that is rented by the administrators of cards or by banking institutions.

The present device and method allow the execution of purchases/sales of services/products, payments received, bank reconciliation of credit operations or payment of bills, sales reconciliation, payments or payments received; payroll loans; consigned credit, financial situations consultation for credit analysis (for example, databases like Serasa), payment of various distributors, recharge of mobile cellphones and prepaid cards, as well as makes it possible to the supplier to launch its own card (private label).

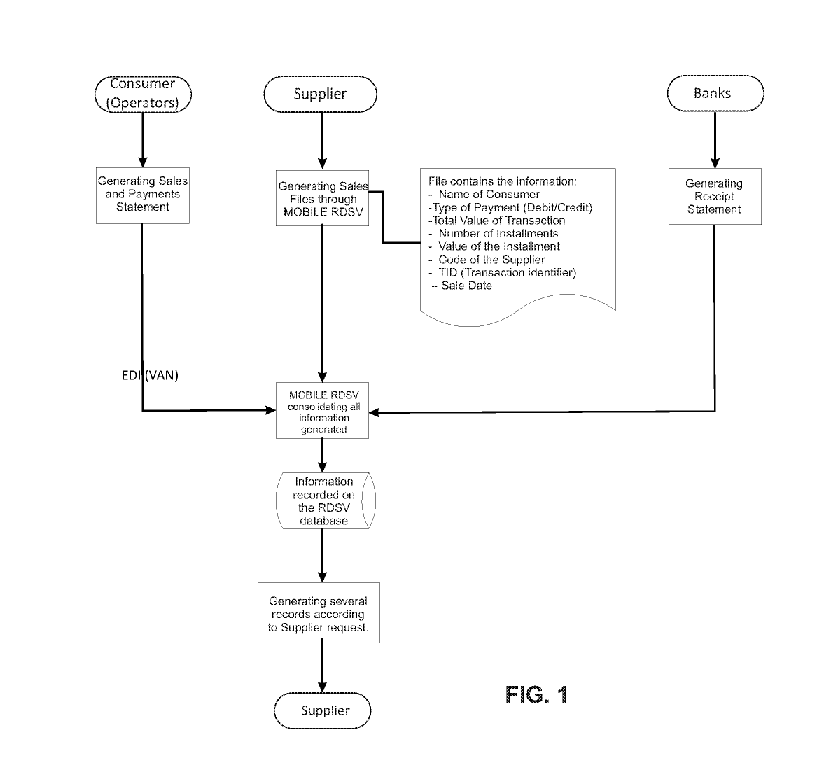

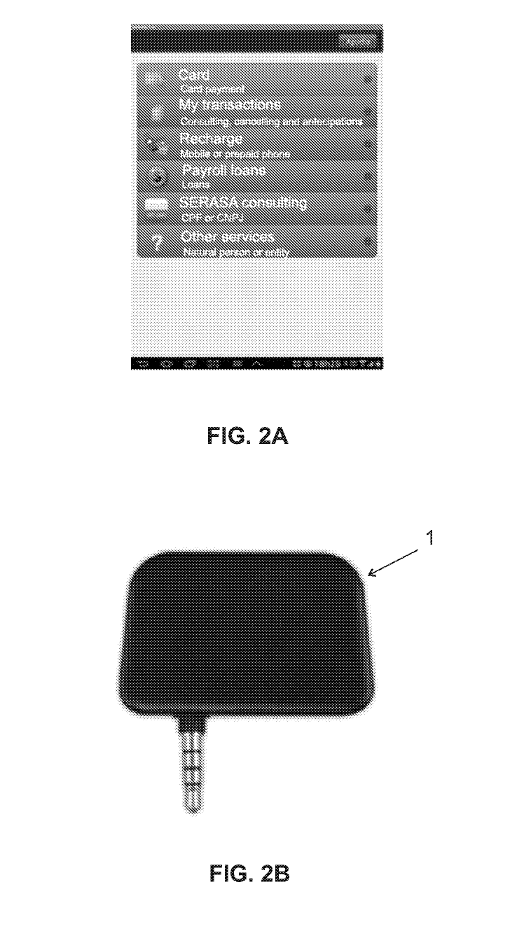

Among the embodiments provided by the present invention, it provides a reconciliation method that is performed through a software application installed on a smart mobile apparatus with internet connection (2). The method is illustrated in the block diagram of FIG. 1, where shows a sales reconciliation method, payment and receipt; according to the following steps:

a) Generating sale files by the supplier;

b) Obtaining the sales statement and consumer payments (from card companies); and/or obtaining payments received statement from the bank;

c) Consolidating generated information in step (a) by the manager and the information obtained in item (b);

d) Recording the information in the manager database;

e) Generating reports according to the supplier's request;

f) Provisioning reports to the supplier.

In this way, the reconciliation is performed from the following information:
Sales Report (Archive)—Company (Commercial Supplier)
Sales and Payments Statement—Operators (Consumers)
Receipt Statement—Banks

The said company's sales report is a record of all company sale transactions, which is generated by this method, or yet by integration of sales system for cashiers or e-commerce; ERP; TEF; or manual spreadsheets.

In order to better achieve the reconciliation with the data of statements of sales and payments of card companies, these files should comprise information such as: Name of consumer; Payment Type (Debit/Credit); Total Value of Transaction; Number of installments; Value of the installments; Supplier Code; TID (Transaction identifier); Date of Sale.

The said Statement of Sale contains the record of all sale transactions that occurred in the previous day.

The Statement of Payment contains the detailed record of the payments made on the current day, related to installment transactions, debit or credit in sight.

The Receiving Statement is the generated file by the Bank which records the amounts received from the card companies. Based on this file, it is possible the validation with precision if all the credits fully informed by the card companies at the time of payment was credited to the bank account.

With this information, the method of reconciliation of sale confronts sales information with the sale statement of card companies, eliminating manual control, which until then was made by the supplier.

In the reconciliation of sale, the values of the transactions, dates of their accomplishments, any canceled sales, chargeback are checked.

The result of the reconciliation of sale allows following up all transactions made in the previous day, based on the analyzes:

Discrepancies in value—Informs any discrepancy of transaction value and where the error occurred, if with the supplier or card company. If the error occurred at the supplier, agility is obtained in the adjustment of internal operational and management processes. If it occurred at the card company, an immediate power of action in the calculation of these discrepancies is gained.

Divergence of dates—Inform any differences in the expected date of payment of each transaction, enabling better management and control of payments received.

Sales Cancelled—Informs all cancellations made and duly recognized by the card consumer, the supplier and the card company, obtaining gains in the management and financial control inherent to receipt of the transactions performed.

Chargeback—Chargeback is the cancellation of a sale made with debit or credit card, which may occur for two reasons: non-recognition of purchase by the cardholder; and, if the transaction does not meet the regulations provided for in the agreements, terms, additives and manuals published by the card company. That is, the supplier sells and then discovers that the sales value shall not be credited because the purchase was considered invalid. If the value has already been credited, it will be immediately reversed or released on debt in the absence of funds at the time of the reversal.

Thus, it is very important to control sales and payments received before the card company, for only then that evidence of chargeback can be raised and the causes determined. The more recent is this analysis, the sooner they can consult the card company for clarification; or, to program for possible losses without the surprise of failure to receipt directly impacts the obligations assumed.

The payment reconciliation method confronts the information recorded and projected in the sales statement of the card company with payment statement of own card company, showing the receipt of each transaction projected.

The result of the payment reconciliation allows clear all evidence regarding to:

Discrepancies in values—Reports differences in amounts actually paid, and these values corresponding to the full or partial sale in question, discounted the administration fee practiced by each card company and negotiated directly with each consumer, each selling arrangement (the credit in sight, debt, installments, etc.). This reconciliation allows fast tracking of any difference in values of each transaction, enabling instant action to recover the difference.

Divergence of dates—Evidence differences in the expected date of payment at the time of registration of the sale, with the date made.

Sales Cancelled—Confirms that all cancellations were deducted from the position to receive, offering support material to record this event.

Chargeback—Confirms if all chargebacks were deducted from the position to receive, offering material support to record the documentation of this event for clarification of these transactions with card company and especially for financial management of the supplier.

Differences in fees—Inform divergence in fees negotiated by the consumer with the card company and the fees at the time of payment. With this reconciliation, the consumer streamlines the recovery of the difference in values resulting from improperly applied fees.

Credit advances—Allows the control of credit advances, relating the original sale and adjusting the flow of receipts in the position of receivables. It also allows controlling the fees at time of anticipation, confronting with the negotiated fees.

The reconciliation of receipt is to confront the information contained in the statement of payment of card operators with receipt statement of banks.

The result of the receipt reconciliation informs potential discrepancies in the amounts received on account in respect of amounts reported by the card companies in the detailed payment statements. This reconciliation serves to certificate whether the full projection receipts for that date corresponds to the credits available in the bank account, with all possible discounts and already provided in other reconciliations.

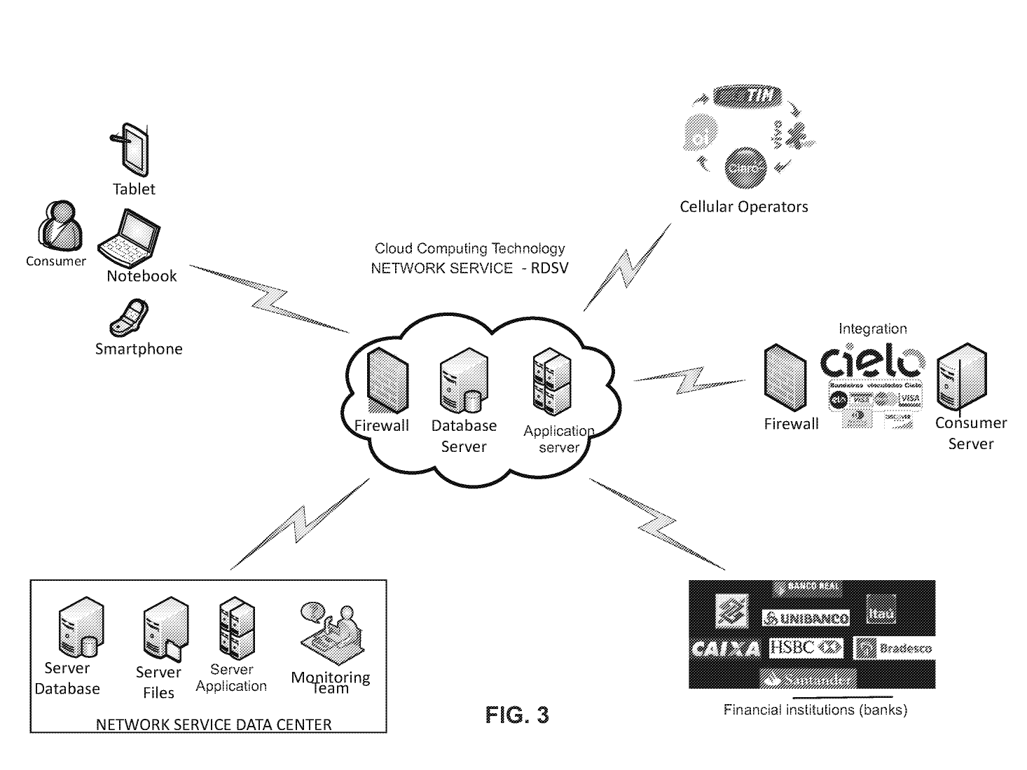

In another embodiment, the present invention relates to a method of management of electronic fund transfer using the device (1), and a program embedded in said mobile apparatus (2) which makes the connection of the card reader device (1) with Web Service, as schematically illustrated in FIG. 3.

The method thus allows the use of financial transaction cards through smart mobile apparatus with internet connection (2) already owned by suppliers or consumers themselves.

Within another aspect, the present invention relates to a method for financial transactions in accordance with the following steps:

a. performing a purchase;

b. requesting online authorization from the manager (RDSV) by the supplier;

c. communicating the manager with the certificator;

d. if transaction unauthorized, recording the transaction information in the server database;

e. informing the supplier that the transaction cannot be performed;

f. if transaction is authorized, authorizing the transaction by the certificator;

g. contacting the credit card company to the issuing Bank and scheduling of the operation value;

h. requesting the transference of the value by the issuing bank;

i. settling the transaction by the Interbank Transfer System;

j. receiving the payment amount by the authorization Bank;

k. performing the payment by the certificator;

l. crediting the payment in the supplier account by the bank of the certificator; and

m. monitoring credit through RDSV by the supplier.

This method of financial transactions enables the consumer to acquire goods or services from suppliers credentialed by the manager (RDSV MOBILE) with a certain credit limit. The manager can work with three kind of available networks (closed, open or shared).

In open networks, the cards are issued by several competing financial institutions, and the authorization authority works for all issuers.

The parties involved are:
consumer is a natural person or entity that uses purchases or services payment card;
issuer is a bank or a non-banking financial institution that provides a card and charges the consumer payment;
supplier is a company or an independent contractor that accepts a card for payment for goods or services;
manager (RDSV MOBILE) provides the operational base (point of sale equipment) to the supplier, performing the capture service, transmission of information related to the transaction;
acquirer or certificator of suppliers makes the transmission of electronic transactions data and deposits the funds in the supplier account;
card company brand licenses its brand to the issuer and the acquirer, and coordinates the system of approval/compensation/settlement.

In this method, the consumer purchase goods or services from a certified supplier, using a card. The supplier requests an online authorization to the Manager (MOBILE RDSV), which communicates with the certificatory.

If the certificator authorizes the transaction, the transfer information is performed, and the card company contacts the issuing bank, scheduling the transaction value. Then, the issuing bank requests the transfer of the transaction value, which is paid by the Interbank Transfer system.

After that, the Bank of the certificator receives the payment amount, recognizing it, and crediting it in the supplier account.

The credits can then be followed by the supplier through the Manager (MOBILE RDSV).

In another example of embodiment, the method comprises steps of purchase transactions using bank cards for payment in cash, by bank transfer; or payment on credit cards.

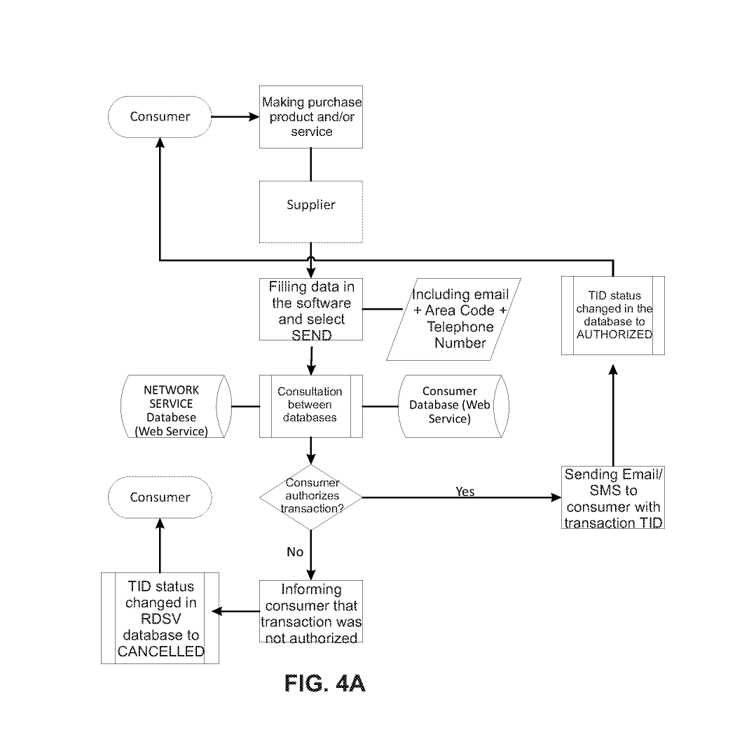

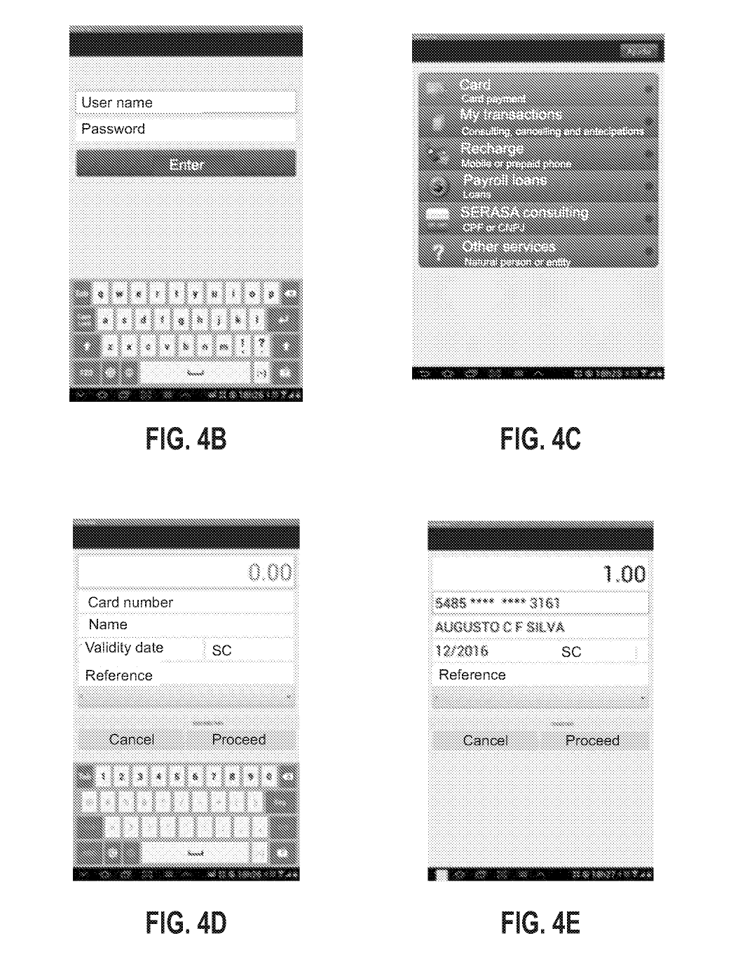

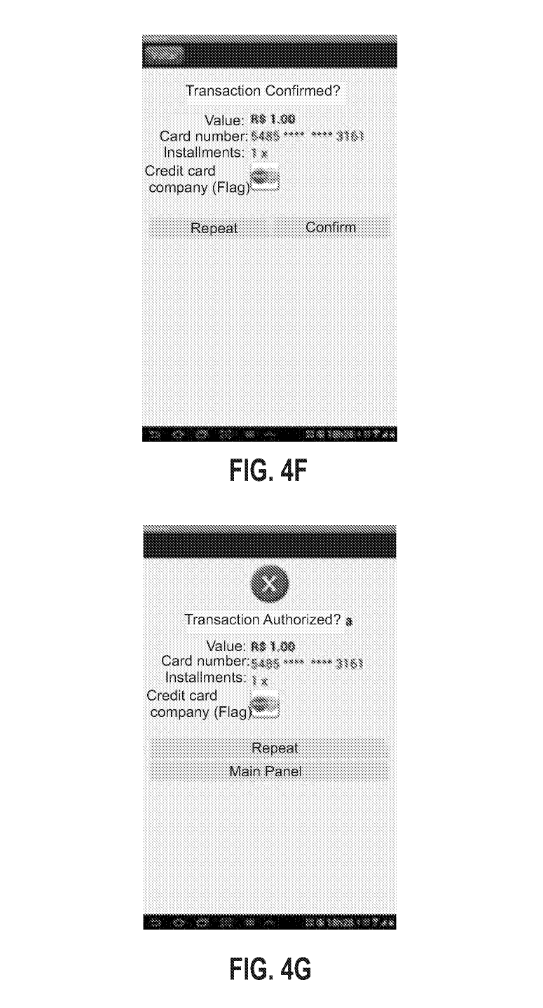

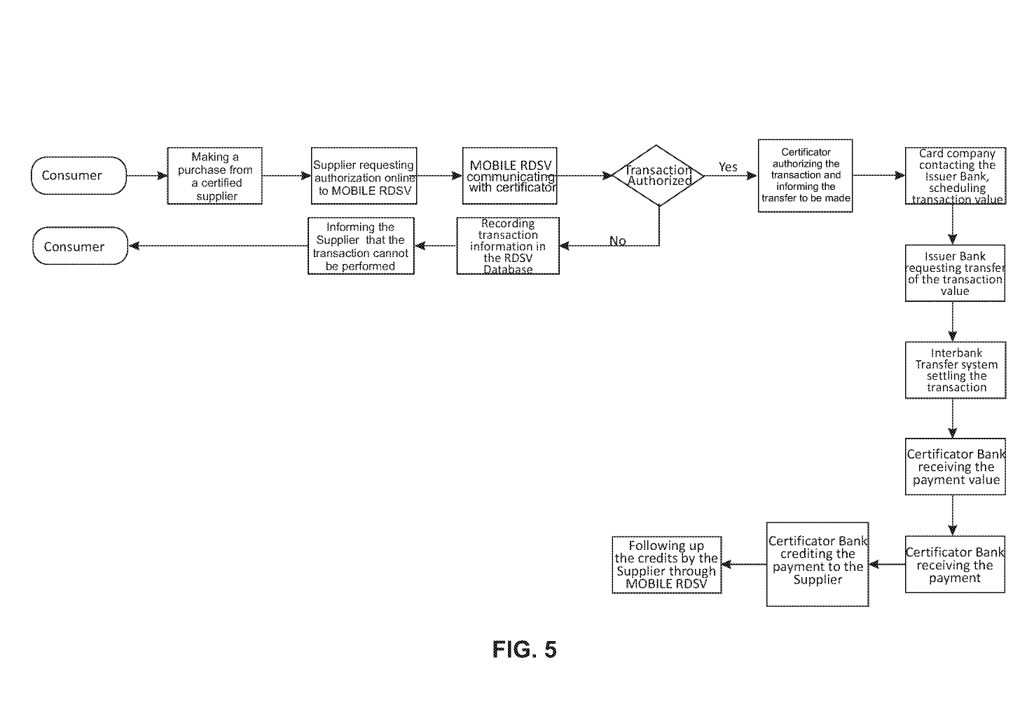

The method requests that the supplier uses “username” (login) and password (see FIG. 4B) to perform it. The supplier then indicates the payment method chosen by the consumer (see FIG. 4C), among credit card (“CARD”) or bank transfer (“CASH”), and consumer data should then be filled in (see FIG. 4D).

In case of choosing “CARD”, the following fields are displayed: card number, transaction amount, carrier name, card validity, security code, reference and number of installments (see FIG. 4E).

Alternatively, the consumer may choose to capture some data by the card reader device (1) through the card positioning in the device (1). Thus, the device (1) automatically captures certain data, such as: card number; consumer name; and card validity. Only a few parameters remain to fill in such as: transaction amount; security code; reference (e.g., description of the transaction selected by the consumer); and the choice of the number of installments.

The present method also comprises the steps that allow installment payments. In this situation, it should choose GO, and then the transaction data is confirmed such as: total value of the transaction, card number (e.g., only the first four and the last four digits), chosen number of installments, and the figure of the consumer card flag (for example, Mastercard). If everything is correct, the consumer clicks on CONFIRM (see FIG. 4F). If there is any problem in the implementation of the transaction, it is canceled and the subject is displayed on the handset screen (2) (see FIG. 4G). Otherwise, the transaction is successful, and is requested “Area Code+Phone Number” and “E-MAIL” of the consumer, for the issuance of copy of transaction data (also sending invoice to the e-mail) for confirmation, which can also print the transaction confirmation coupon.

When the transaction is performed, the card company generates a transaction identifier (TID) according to the data of the transaction, in this example which a credit card is used.

The supplier may trigger the manager system (RDSV) web module to follow up and reconcile the payments received. Optionally the program can work with different colors, one for each kind of transaction status, e.g., red transactions are not received transactions; yellow transactions are transactions that should be paid to the supplier in consultation date; transactions in blue are transactions whose term of payment will be in seven days or more; and transactions in gray are blocked transactions, which are cases of reversal, suspected fraud, among others. By the end of the month, it is possible to draw a report from the card company's system from the first to the thirtieth day of the current month, and export it in a “.txt” format, for example, by clicking a tab entitled RECONCILIATION OF CREDIT OPERATIONS of the manager system (RDSV), where it is chosen the month and the year, making an import of the file generated by the card company. Once imported, click on CONCILIATE OPERATION, and the method reconciles the information handed as paid by the consumer with the information that the manager (RDSV) handed to the consumer. If the entire information match, it is generated a report without impugnment. If there are any differences, a report is generated with all the information of the transactions that occurred differences, and the card operator drives the consumer to verify the non-payment of these transactions.

An application practical example of this method is the payment of a restaurant bill. The supplier swipe the consumer's credit card in the device (1) coupled to a mobile apparatus (2). The transaction is captured and transaction information is sent to the card company (Cielo or Redecard). The company validates or not the transaction. If the transaction is validated, a validation message is sent to the manager, who issues a Payment Voucher to the Supplier, and updates the accounts receivable of the Supplier. Then, the manager reports the transaction to the Issuer Bank of the Card (Brasil, Bradesco, Itaú, etc.) and the consumer is charged for the debt.

In one embodiment, illustrated in FIG. 4A, the method comprising the steps of:
selecting a certified supplier;
filling in the data (e-mail, phone, consumer), and selecting SEND;
consulting consumer and manager databases through Web Service;
if the authorization is granted, sending e-mail/SMS with transaction ID to the consumer;
modifying the transaction ID to AUTHORIZED in the database;
if the authorization is not granted, informing consumer that transaction was unauthorized;
modifying the transaction ID to CANCELLED in the database.

This particular embodiment concerns a purchase of goods or contracting of services using the card reader device (1) and the present method. The consumer selects a “Certified Supplier” to make the purchase. The supplier fulfills the necessary data on the mobile apparatus (2) to which the device (1) is connected, and the program embedded in it performs the application by sending the request as shown in FIGS. 4B, 4C, 4D and 4E.

A query in the manager (RDSV) and consumer database validates the data and proceeds. If the data is correct the consumer can authorize the transaction, and receive an e-mail/SMS with the transaction ID (TID) confirming the transaction and registering in the program, as shown in FIG. 4F. If the data entered is not allowed, the program informs that the transaction is not authorized and the registration is canceled for that TID, as shown in FIG. 4G.

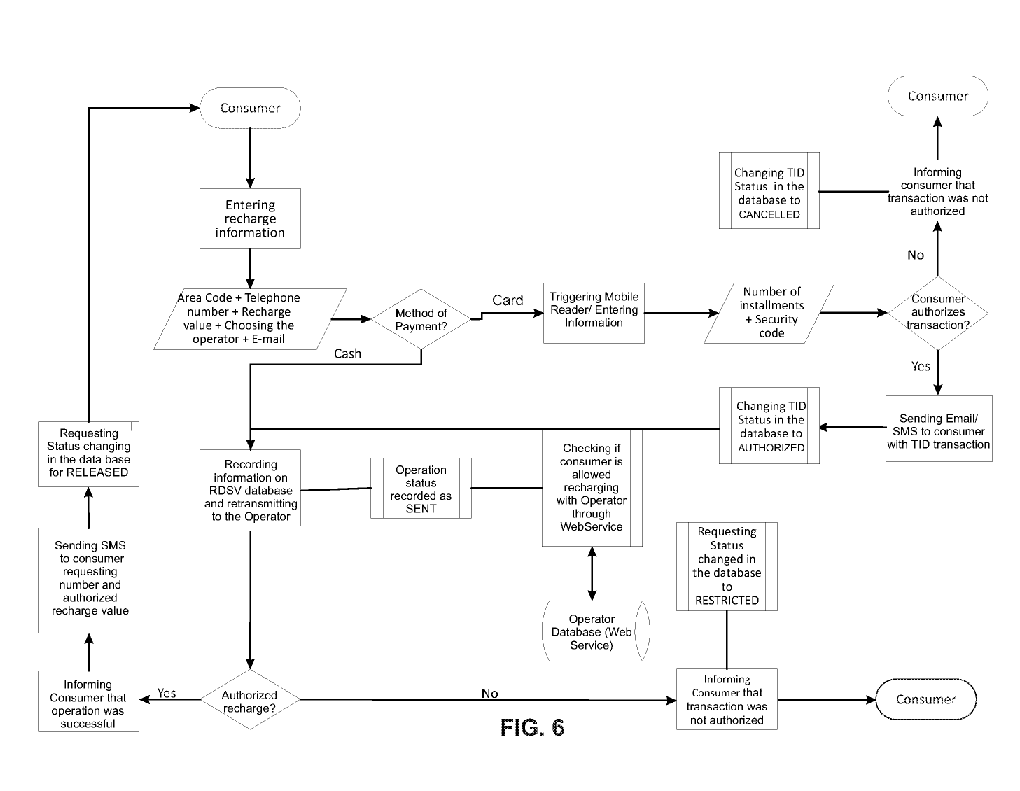

In another example of application of this method, the fund transfer is performed for phone recharging, as shown in FIG. 6, the method comprises the following steps:

a. filling in the data for recharge (phone, value of the recharge, the mobile operator, e-mail);

b. if payment is in cash, recording the information in the manager database (RDSV), retransmitting to the mobile operator, saving the status operation as sent, checking if the consumer has authorization to recharge mobile operator through Web Service;

c. if the recharge is authorized, reporting the consumer that operation was successful;

d. sending a SMS to the consumer requesting number and value of the authorized recharge;

e. changing the status of the request for AUTHORIZED in the database;

f. if the recharge is refused, informing the consumer that the transaction was not authorized, changing the status for UNAUTHORIZED in the database;

g. if payment by card, activating the card reader device (1), and filling in information of payment (number of installments and security code);

h. if the transaction is authorized, sending e-mail/SMS with transaction ID of the consumer, changing the ID of the transaction for AUTHORIZED in the database, going to the cash payment stage;

i. if transaction not authorized, informing the consumer that the transaction was refused, changing the transaction ID in the database for CANCELLED.

This particular embodiment concerns a method of recharging prepaid mobile phones, where the consumer fills in the details of recharge, phone number, the recharge value, choose the operator and e-mail. Then, he chooses the payment method from cash or credit card. If card is chosen, the card reader device (1) is activated to allow the use of credit card. The method demands the value of recharge, the number of installments and the security code.

If the transaction is not authorized, the consumer receives the information, and the status of the transaction ID (TID) is changed to CANCELLED.

If the transaction is authorized, the consumer receives an e-mail/SMS with the TID, and the transaction status becomes AUTHORIZED in the database. Similar to the card payment that is authorized, if the consumer chooses cash payment, the information is stored on the Manager Database (RDSV) and transmitted to the specific mobile operator, which checks the consumer recharge and confirms or not the request. If the request is approved, an SMS is sent to the consumer and the recharge is performed, the requested status is stored in the database. If the request is not authorized by the mobile operator, the consumer receives the information of request Not Authorized, and the status of the transaction is stored in the database as CANCELLED.

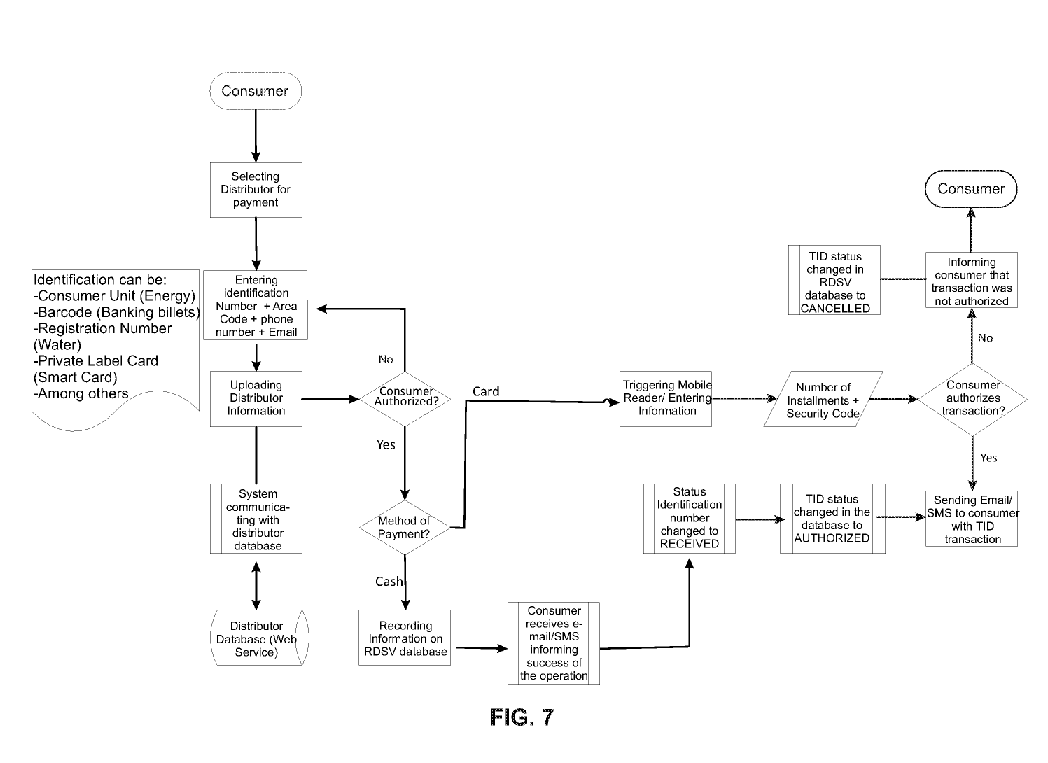

In a further embodiment, wherein the fund transfer is performed for payment of a distributor (of water, electricity, gas, etc.), as illustrated in FIG. 7, the method comprises the following steps:

a. selecting of a distributor for payment;

b. filling in the data (identification number, telephone number and e-mail);

c. uploading information through communication with the distributor database system through Web Service;

d. if consumer refused, returning to fill in data step;

e. if consumer authorized, selecting the payment method;

f. if cash payment, storing information in the MANAGER database;
receiving e-mail/SMS informing success of the operation;

g. changing the status of identification number to RECEIVED, changing the status of the transaction ID to AUTHORIZED in the database, sending e-mail/SMS with the transaction ID to consumer;

h. if payment by credit card, activating the device (1);

i. filling in information (number of installments and security code);

j. if transaction rejected, informing the consumer, modifying transaction ID to CANCELLED in the database;

k. if authorized transaction.

This particular embodiment concerns a payment method at distributors (water, electricity, gas, etc.), where the consumer can choose who makes the payment, choosing between different distributors. Consumers enter the account code or barcode, enter the phone number, e-mail, and then send the request for payment to the Distributor. If the data is not correct, the consumer chooses the payment method, and enters the data again. If the choice is by cash payment, the information is recorded in the MANAGER database and the consumer receives an e-mail/SMS informing the success of the operation and changing the TID status to RECEIVED. If a card is chosen to payment, the card reader device (1) is activated; the number of installments and the card security code are required. If the transaction is accepted, an e-mail/SMS is sent with the TID number for the consumer and the authorization is stored in the database. If the transaction is not accepted, the information of not authorization and TID are recorded as CANCELLED in the database and the situation is informed to the consumer.

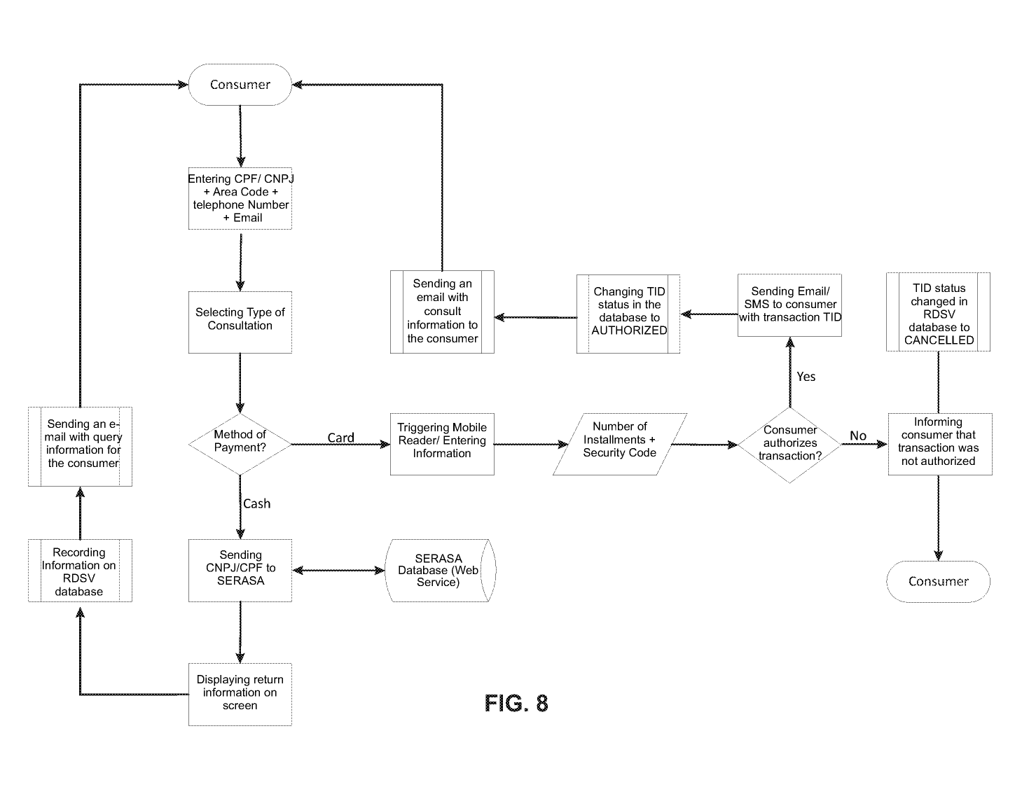

In a further embodiment, wherein the fund transfer is performed for payment of a consultation of financial situation of a person or entity, as illustrated in FIG. 8, the method comprises the following steps:

a. filling in consumer data;

b. selecting a consultation;

c. if selected payment is cash, sending tax registration of person or entity to consult the database through Web Service;

d. displaying consult information on the screen;

e. recording information in the manager database;

f. sending e-mail with consult information to consumer;

g. if selected payment is card, activating card reader device (1);

h. selecting number of installments and filling in the security code;

j. if transaction rejected, informing the consumer, modifying ID for CANCELLED in the database;

j. transaction is accepted, sending e-mail/SMS with TID for consumer, changing status of TID to AUTHORIZED in the database, and sending e-mail with consult information to consumer.

This particular embodiment concerns a method that allows the verification of a credit/financial situation person or entities, for example, in databases of companies like SERASA, which informs if a person or entity has debts, by informing the tax registration number of the person or entity to the company. When choosing the form of payment, for example, money, the consumer may request an analysis from the tax registration number of a person/entity in the database of the said SERASA. The request is displayed on the mobile apparatus screen (2), recorded in the MANAGER database and sent to the consumer by e-mail. If the selected payment is by credit card, the card reader device (1) is activated, and the number of installments and the security code is required. Once authorized, an e-mail/SMS with the TID and information requested is sent to the consumer, then the status of the TID is changed to AUTHORIZED. If the transaction is not authorized, the consumer receives information of non-authorization, and the status of the TID changes to CANCELLED.

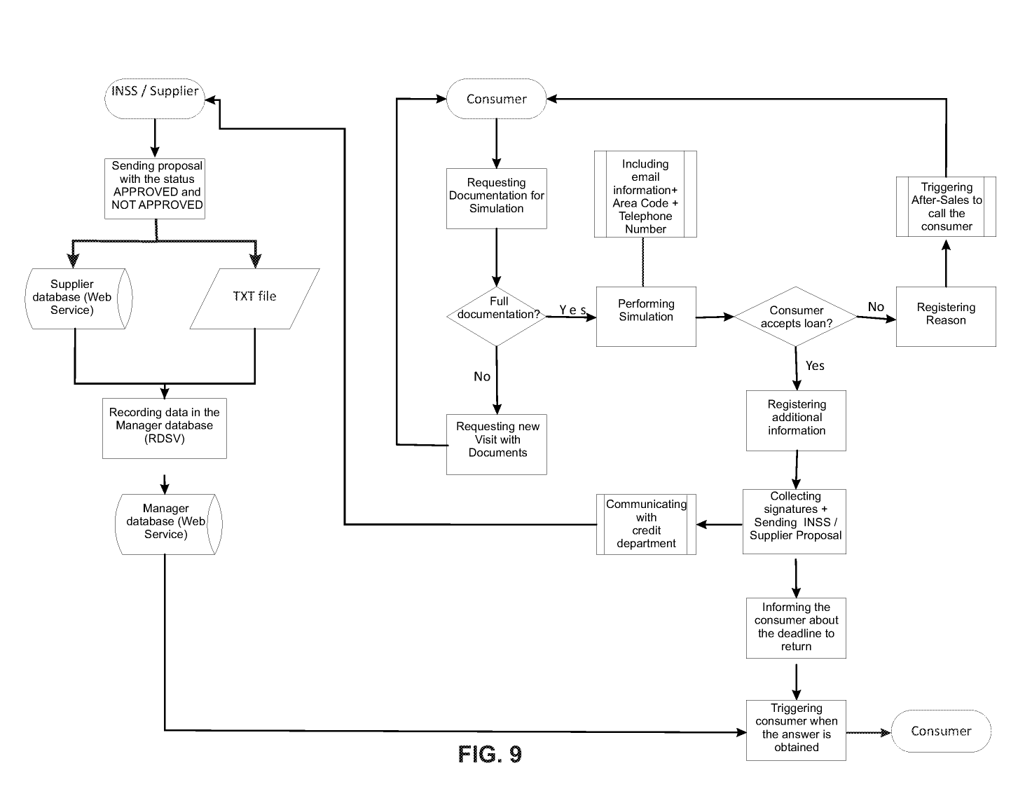

In a further example of embodiment, wherein the fund transfer is performed for payment of a loan, as illustrated in FIG. 9, the method comprises the following steps:

a. requesting documents for the consumer to loan simulation;

b. if documentation incomplete, requesting the documents again;

c. if documentation complete, simulating is done;

d. if the consumer does not accept loan, recording the reason, and after-sales is triggered to contact the consumer;

e. if consumer accepts loan, recording additional information, collecting signatures, sending proposal, contacting with credit bureau, sending proposals with status OK or FAIL in .txt file or Web Service, recording information;

f. informing the consumer to return;

g. contacting the consumer when a response is received.

This particular embodiment concerns a loan simulation method, where the consumer and the Financial Agent simulate a loan through document requesting, and recording the consumer data. Or yet, in the absence of documents, requests the consumer to return later with all necessary documents. Then the Agent may agree or not with the loan. If the agent does not agree, he is requested to write his reasons. The reasons trigger the after sales department to retrieve the consumer. If the consumer agrees with the loan, other information is requested, signatures are collected and the proposal is sent to the Insurance credit bureau, and the status is recorded in the Financial Agent (Bank) and MANAGER database. Then, the consumer is informed to return and the program triggers the consumer when all the answers to finalize the loan are obtained.

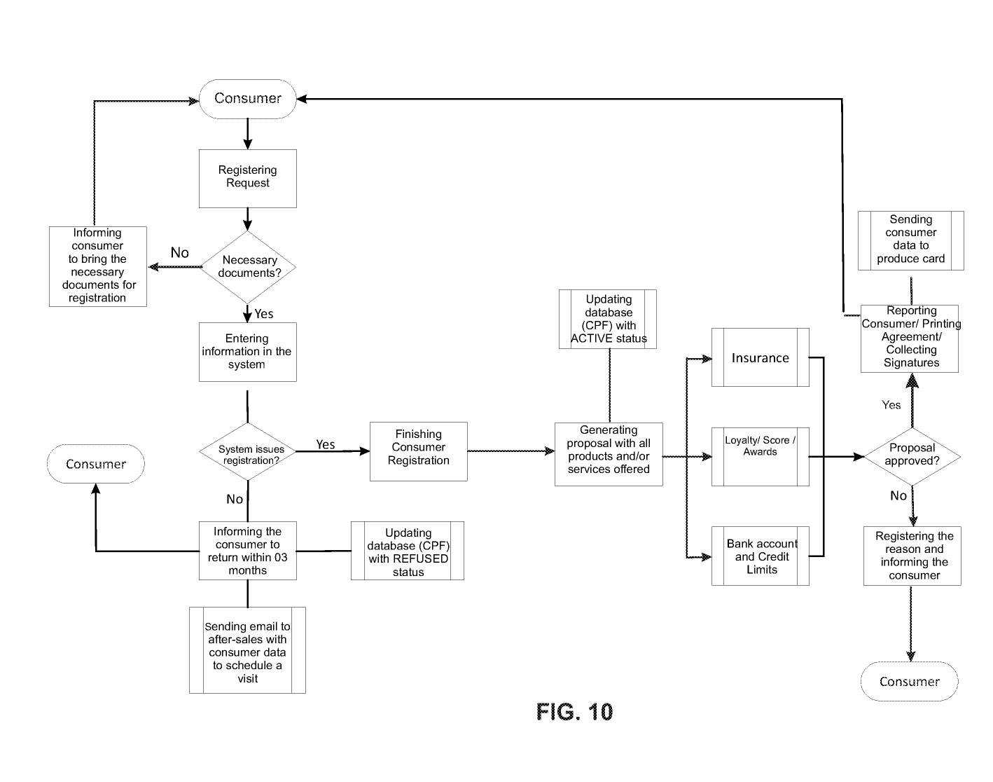

In a further example of embodiment, wherein the fund transfer is performed to request of loyalty card, as illustrated in FIG. 10, the method comprises the following steps:

a. requesting a card by the consumer with submission of documents;

b. if documents are not enough, requesting complementation;

c. if documents are sufficient, recording the information in the system, checking the documents in MANAGER and Supplier Database through Web Service by exchanging information;

d. if the registration is not authorized, informing the consumer to return in three months, updating the status of the registration of the person/entity in the database as Refused, and sending an e-mail to after-sales with consumer data to schedule a visit;

e. if the registration is authorized, completing the registration, updating the status of the registration of the person/entity in the database for Active;

f. generating a proposal with all the products/services offered;

g. if the proposal is refused, recording the reason and informing the consumer, updating the status of the registration of the person/entity in the database as Refused, informing the consumer to return in three months and sending an e-mail for after-sales with consumer data to schedule a visit;

h. if the proposal is approved, informing the consumer, printing the agreement, collecting signatures;

i. sending by the consumer the data to make the card;

j. sending the card.

This particular embodiment concerns a method for Private Label card systems. The consumer requests a registration, and he does not have the necessary documents, the system requests the consumer to return with the necessary documents. If the consumer has the documents, this information is recorded in the system, checked and compared between the Manager database and other databases. If the registration is authorized, the consumer registration is changed to ACTIVE and a proposal is generated with all the products and/or services available such as insurance, loyalty card, scores, awards, bank account and credit limit.

If the proposal is approved, the agreement is printed for signatures; the card is made and sent. If the proposal is not accepted, or if the registration is not authorized, the reasons are recorded in the database, and then the consumer is informed to return in three months. The after-sales department receives an e-mail to schedule a visit.

For security of the system, the transactions are encrypted in 03 moments: when the consumer swipes the card in the card reader device (1); when the supplier confirms the transaction, the transaction information is decrypted and encrypted again to travel over the internet to the card company (2nd moment); and when the information is considered valid by the card company that returns the information, and such information is recorded in the manager database in an encrypted form.

The content of this disclosure can be used by a person skilled in the art in ways not specifically described, and it is well understood that different alternatives, performing the same or similar functions achieve the same or similar results are within the scope of protection of the invention, whose extension corresponds to the content of the appended claims.

1- Reconciliation method of financial transactions performed through application software embedded on a smart mobile apparatus with internet connection (2) characterized in that it comprises the following steps:
a) Generating sale files by the supplier;
b) Obtaining the sales statement and consumer payments (operator); and/or obtaining receivement statement from the bank;
c) Consolidating generated information in step (a) by the manager and the information obtained in item (b);
d) Recording the information in the manager database;
e) Generating reports according to the supplier's request;
f) Provisioning reports to the supplier.

2- Card reader device to a mobile network services, to be coupled to a smart mobile apparatus with Internet connection (2), characterized in that it comprises a card reader of financial transaction trough an opening for insertion/swipe of a card, where said card is chosen among bank card, credit card, smartcard, loyalty card; the device (1) is further provided with a connector that is coupled to the headphone input of the apparatus (2) in order to enable the use of the apparatus (2) in financial transactions.

3- Management method of electronic fund transfer performed through application software embedded on a smart mobile apparatus with internet connection (2) characterized in that it comprises the following steps:
a. performing a purchase;
b. requesting online authorization from the manager (RDSV) by the supplier;
c. communicating the manager with the certificator;
d. if transaction unauthorized, recording the transaction information in the server database;
e. informing the supplier that the transaction cannot be performed;
f. if transaction is authorized, authorizing the transaction by the certificator;
g. contacting the credit card company to the issuing Bank and scheduling of the operation value;
h. requesting the transference of the value by the issuing bank;
i. settling the transaction by the Interbank Transfer System;
j. receiving the payment amount by the authorization Bank;
k. performing the payment by the certificator;
l. crediting the payment in the supplier account by the bank of the certificator; and
m. monitoring credit through RDSV by the supplier.

4- Method, according to claim 3, further comprising a filling and sending stage of a consumer data after step (a), followed by a consulting step in the consumer and manager databases through Web service; the authorization in step (f) enables sending an e-mail/SMS with transaction ID to the consumer modified to AUTHORIZED; and that the step of non-authorization (d) modifies the transaction ID for CANCELLED.

5- Management method of electronic fund transfer performed through application software embedded on a smart mobile apparatus with internet connection (2) wherein the transfer fund is provided to recharge of phone, characterized in that it comprises the following steps:
a. filling in the data for recharge (phone, value of the recharge, the mobile operator, e-mail);
b. if payment is in cash, recording the information in the manager database (RDSV), retransmiting to the mobile operator, saving the status operation as sent, checking if the consumer has authorization to recharge mobile operator through Web Service;
c. if the recharge is authorized, reporting the consumer that operation was successful;
d. sending a SMS to the consumer requesting number and value of the authorized recharge;
e. changing the status of the request for AUTHORIZED in the database;
f. if the recharge is refused, informing the consumer that the transaction was not authorized, changing the status for UNAUTHORIZED in the database;
g. if payment by card, activating the card reader device (1), and filling in information of payment (number of installments and security code);
h. if the transaction is authorized, sending e-mail/SMS with transaction ID of the consumer, changing the ID of the transaction for AUTHORIZED in the database, going to the cash payment stage;
i. if transaction not authorized, informing the consumer that the transaction was refused, changing the transaction ID in the database for CANCELLED.

6- Management method of electronic fund transfer performed through application software embedded on a smart mobile apparatus with internet connection (2) wherein the fund transfer is performed for payment of a distributor, characterized in that it comprises the following steps:
a. selecting of a distributor for payment;
b. filling in the data (identification number, telephone number and e-mail);
c. uploading information through communication with the distributor database system through Web Service;
d. if consumer refused, returning to fill in data step;
e. if consumer authorized, selecting the payment method;
f. if cash payment, storing information in the MANAGER database;
receiving e-mail/SMS informing success of the operation;
g. changing the status of identification number to RECEIVED, changing the status of the transaction ID to AUTHORIZED in the database, sending e-mail/SMS with the transaction ID to consumer;
h. if payment by credit card, activating the device (1);
i. filling in information (number of installments and security code);
j. if transaction rejected, informing the consumer, modifying transaction ID to CANCELLED in the database;
k. if authorized transaction.

7- Management method of electronic fund transfer performed through an application software embedded on a smart mobile apparatus with internet connection (2) wherein the fund transfer is performed for consulting of financial situation of a person or entity, characterized in that it comprises the following steps:
a. filling in consumer data;
b. selecting a consultation;
c. if selected payment is cash, sending tax registration of person or entity to consult the database through Web Service;
d. displaying consult information on the screen;
e. recording information in the manager database;
f. sending e-mail with consult information to consumer;
g. if selected payment is card, activating card reader device (1);
h. selecting number of installments and filling in the security code;
j. if transaction rejected, informing the consumer, modifying ID for CANCELLED in the database;
j. transaction is accepted, sending e-mail/SMS with TID for consumer, changing status of TID to AUTHORIZED in the database, and sending e-mail with consult information to consumer.

8- Method of management of electronic fund transfer, where the fund transfer is performed to a loan, comprising the steps of:
a. requesting documents for the consumer to loan simulation;
b. if documentation incomplete, requesting the documents again;
c. if documentation complete, simulating is done;
d. if the consumer does not accept loan, recording the reason, and after-sales is triggered to contact the consumer;
e. if consumer accepts loan, recording additional information, collecting signatures, sending proposal, contacting with credit bureau, sending proposals with status OK or FAIL in .txt file or Web Service, recording information;
f. informing the consumer to return;
g. contacting the consumer when a response is received.

9- Management method of electronic fund transfer performed through application software embedded on a smart mobile apparatus with internet connection (2) wherein the fund transfer is performed to request of loyalty card, characterized in that it comprises the following steps:
a. requesting a card by the consumer with submission of documents;
b. if documents are not enough, requesting complementation;
c. if documents are sufficient, recording the information in the system, checking the documents in MANAGER and Business Database through Web Service by exchanging information;
d. if the registration is not authorized, informing the consumer to return in three months, updating the status of the registration of the person/entity in the database as Refused, and sending an e-mail to after-sales with consumer data to schedule a visit;
e. if the registration is authorized, completing the registration, updating the status of the registration of the person/entity in the database for Active;
f. generating a proposal with all the products/services offered;
g. if the proposal is refused, recording the reason and informing the consumer, updating the status of the registration of the person/entity in the database as Refused, informing the consumer to return in three months and sending an e-mail for after-sales with consumer data to schedule a visit;
h. if the proposal is approved, informing the consumer, printing the agreement, collecting signatures;
i. sending by the consumer the data to make the card;
j. sending the card.
